(19) United States
(12) Patent Application Publication
(10) Pub. No.: US 2011/0203543 A1
(43) Pub. Date: Aug. 25, 2011

(54) MONITORING OF THE EXCITATION FREQUENCY OF A RADIOFREQUENCY SPARK PLUG

(75) Inventors: Andre Agneray, Boulogne-Billancourt (FR); Frederic Auzas, Paris (FR); Franck Deloraine, Fontenay-aux-roses (FR); Maxime Makarov, Viroflay (FR)

(73) Assignee: RENAULT s.a.s., Boulogne-Billancourt (FR)

(21) Appl. No.: 13/057,349

(22) PCT Filed: May 15, 2009
(86) PCT No.: PCT/FR2009/050912

§ 371 Date: May 2, 2011

(30) Foreign Application Priority Data
Aug. 5, 2008 (FR) 0855409

(51) Int. Cl. F02P 23/00; H05H 1/24

(52) U.S. Cl. 123/143 B; 315/111.21

(57) ABSTRACT

A radiofrequency plasma generating device, including: a control module generating a control signal at a control frequency, a power supply circuit including a breaker switch controlled by the control signal, the breaker switch applying an excitation signal to an output of the power supply circuit at the control frequency defined by the control signal, a resonator exhibiting a resonant frequency of greater than 1 MHz, connected to the output of the power supply circuit and adapted to generate a voltage for making a spark when it is excited by the excitation signal, and a mechanism monitoring the control module and configured to modify the frequency of the resonator excitation signal in a manner synchronous with the control signal, during application of the excitation signal.

The present invention relates to the field of the radiofrequency power supply of resonators, in particular of resonators used in plasma generators.

For an application to plasma generation automobile ignition, resonators whose resonant frequency is greater than 1 MHz are arranged at the level of the spark plug and are typically supplied at high voltage (for example greater than 100 V) and subjected to heavy currents (for example stronger than 10A).

The operation of the radiofrequency high-voltage power supply of the spark plug is based on the phenomenon of series resonance in the resonator, whose resonant frequency is determined by the value of the intrinsic parameters of the circuit constituting the resonator.

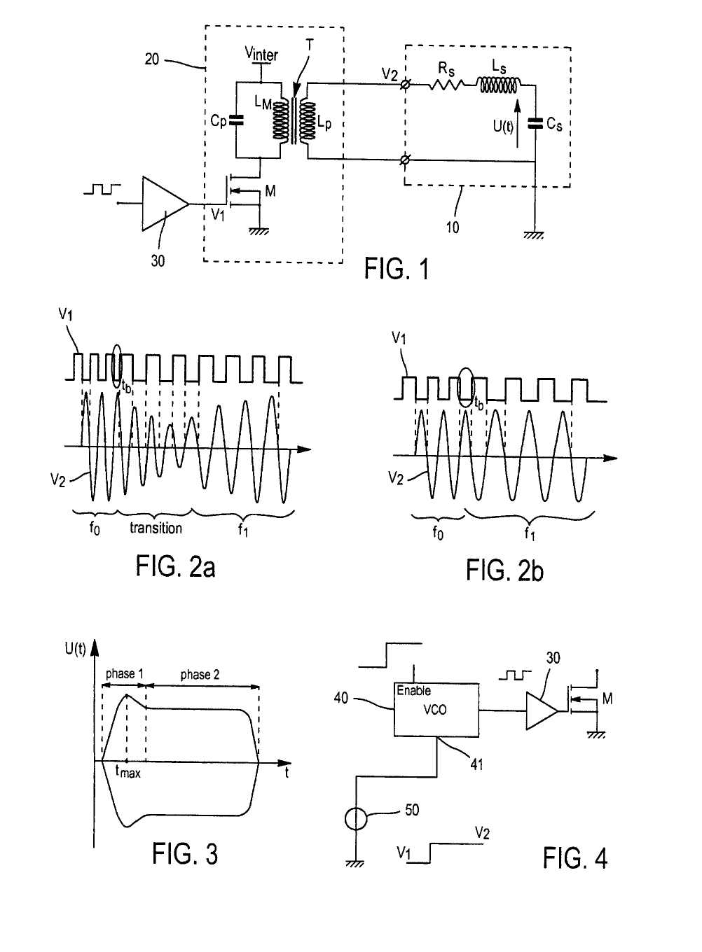

FIG. 1 illustrates a resonant radiofrequency ignition system of the prior art. The plasma generation resonator 10, modeling the radiofrequency spark plug, comprises in series a resistor R_{S}, an inductor L_{S} and a capacitor C_{S}, whose values are fixed during fabrication by the geometry and the nature of the materials used, in such a way that the resonator exhibits a resonant frequency of greater than 1 MHz.

The resonator 10 is connected to an output of a power supply circuit 20, exhibiting a MOSFET transistor of power M acting as breaker, so as to apply an intermediate voltage Vinter to the output of the power supply circuit, at a frequency defined by a control signal V1 applied to the gate of the MOSFET by way of a control module 30.

The intermediate voltage Vinter is for example delivered on the output of the power supply circuit at the frequency defined by the control signal, by way of a parallel resonant circuit comprising a capacitor Cp in parallel with a coil L_{M} forming the primary winding of a transformer T, the resonator 10 being connected to the terminals of the secondary winding LP of the transformer.

Thus, the control module 30 provides the control signal V1, making it possible to drive at a frequency substantially equal to the resonant frequency of the plasma generation resonator, for example around 5 MHz, the switchings of the transistor M delivering to the parallel resonator 21 the voltage Vinter, typically lying between 12V and 250 v, which will then be amplified. At the control frequency applied, an exchange of energy between the parallel resonator and the resonator 10 of the radiofrequency spark plug is created, making it possible to attain at the output of the resonator 10 the breakdown threshold voltage at the temperature and the pressure of the medium in which it is desired to produce the spark.

The control frequency is therefore chosen as being the resonant frequency of the plasma generation resonator 10.

Now, the formation of the spark at the output of the resonator disturbs and mistunes the system. Indeed, a spark in a gas, like any electrical conductor, is characterized by a capacitance. So, if spark-less, it is the parameters R_{S}, L_{S} and C_{S}, specific to the resonator 10, which alone determine the resonant frequency of the system. This is no longer the case upon the formation of a spark; the characteristics specific to the latter do indeed modify the resonant frequency.

The difference between the actual resonant frequency of the resonator with a spark formed and the control frequency of the radiofrequency power supply of the spark plug, chosen as being the no-load resonant frequency of the spark plug (f₀), that is to say adjusted for a spark-less system, then gives rise to a degradation of the quality factor of the resonator (or overvoltage factor, defining the ratio of the amplitude of its output voltage to its input voltage as a function of the frequency applied to the resonator).

Also, it would appear to be useful to be able to realign the control frequency of the radiofrequency power supply in real time inside an excitation train for the resonator, so as to maintain the amplitude of the voltage at the tip of the spark plug and therefore, the properties of the spark such as its size and the degree of its forking. The present invention is aimed at meeting this objective, without decreasing the effectiveness of the system.

With this objective in view, the invention therefore relates to a radiofrequency plasma generation device, comprising:
a control module generating a control signal at a control frequency,
a power supply circuit comprising a breaker controlled by the control signal, the breaker applying an excitation signal to an output of the power supply circuit at the frequency defined by the control signal,
a resonator exhibiting a resonant frequency of greater than 1 MHz, connected to the output of the power supply circuit and suitable for generating a voltage for producing a spark when it is excited by the excitation signal,

said device being characterized in that it comprises drive means for the control module, suitable for modifying the frequency of the resonator excitation signal in a manner synchronous with the control signal, during the application of said excitation signal.

Preferably, the drive means are suitable for controlling at least one frequency jump of the control signal from a first frequency value to a second frequency value, less than said first value.

Advantageously, the drive means are suitable for controlling a duration of toggling of the control signal to the second frequency value, lying between 80% and 120% of the duration of a half-period of said signal at the first frequency value.

Preferably, the first frequency value is substantially equal to the resonant frequency of the resonator when spark-less.

Advantageously, the second frequency value lies in a span lying between f₀−(Δf/2) and f₀, f₀ being equal to the resonant frequency of the resonator when spark-less and Δf corresponding to the passband of the resonator.

According to one embodiment, the drive means are suitable for controlling a frequency jump of the control signal in a transient phase of the voltage signal generated by the resonator, preceding a phase of stabilization of said signal.

Preferably, the drive means are suitable for controlling a frequency jump of the control signal, substantially at the moment of the formation of the spark.

According to one embodiment of the invention, the control module drive means comprise a voltage-controlled oscillator and means for modulating the drive voltage of said oscillator.

The invention also relates to an internal combustion engine, characterized in that it comprises at least one plasma generation device according to the invention.

The invention further relates to a method of controlling a power supply of a radiofrequency ignition of a combustion engine, in which an excitation signal is applied as input to a resonator at a first frequency defined by a control signal, said resonator exhibiting a resonant frequency of greater than 1 MHz and being able to generate a voltage for producing a spark when it is excited by the excitation signal, said method being characterized in that it consists in modifying the frequency of the excitation signal during the application of the latter, in a manner synchronous with the control signal.

Other characteristics and advantages of the invention will emerge clearly from the description thereof given hereinafter, by way of wholly nonlimiting indication, with reference to the appended drawings, in which:

FIG. 1 schematically illustrates a radiofrequency plasma generation device of the prior art;

FIG. 2a represents two timecharts relating respectively to the voltage control signal for the MOS breaker of the radiofrequency power supply and the signal of the excitation current input to the resonator of the radiofrequency spark plug, in the case of a change of frequency of the control signal unsynchronized with the excitation signal, in the course of a command controlling the ignition of the spark plug;

FIG. 2b repeats the timecharts of the previous figure, in the case of a change of frequency of the control signal, synchronized with the excitation signal, according to the principle of the invention;

FIG. 3 illustrates the voltage signal U(t) of the resonator as a function of time during a plasma generation control command, that is to say the signal which is applied to the terminals of the capacitor c_{S} of the plasma generation resonator;

FIG. 4 illustrates an embodiment of the means of synchronous frequency driving of the control signal of the radiofrequency power supply.

The optimization of the development of the spark of the radiofrequency spark plug requires the successful recouping of part of the mistuning of the system due to the formation of the spark, so as to best approximate the new resonance conditions of the assembly.

To do this, the invention proposes to modify in real time the frequency of the control signal V1 of the breaker M, controlling the application of the excitation signal V2 of the resonator 10 of the radiofrequency spark plug at the output of the power supply circuit 20, during the application of this excitation signal.

One embodiment consists in modifying the control frequency during an excitation train, according to an abrupt shift of the frequency, imposed substantially at the moment of the formation of the spark (just before or just after the establishment of the spark).

Preferably, this frequency shift consists in decreasing the frequency of the power supply control signal, from a first frequency value, fixed on startup of the ignition control and corresponding typically to the no-load resonant frequency f₀ of the system, to a second frequency value, preferably lying between f₀−(Δf/2) and f₀, with Δf corresponding to the passband of an RLC circuit, in this instance the one forming the resonator 10. By way of example, in the present application, Δf/2 can take a value substantially equal to 100 kHz.

FIG. 3 illustrates an example of the voltage envelope of the signal U(t) taken across the terminals of the capacitor C_{S} of the resonator for a control profile such as described hereinabove, i.e. with a first frequency value f₀ preserved up to the voltage maximum attained for the instant tₘₐₓ of the control, corresponding to the moment of formation of the spark, and a second frequency value decreased abruptly to f₀−50 kHz with respect to the first frequency value, after the instant tₘₐₓ.

Indeed, according to the example given hereinabove, the equivalent capacitance that will be afforded by the spark will not generally involve a decrease in the resonant frequency of the resonator/spark assembly of more than 100 kHz with respect to f₀.

Such a control profile advantageously makes it possible to preserve the maximum amplitude of the voltage applied across the terminals of the capacitor C_{S} of the resonator at the moment tₘₐₓ of formation of the spark, and furthermore lessens the voltage drop after the passage of the point of maximum voltage at tₘₐₓ and renders said drop more progressive with respect to the conventional case without frequency driving of the control during the application of the resonator excitation signal.

Such a modification of the control frequency during the application of the radiofrequency spark plug resonator excitation signal, therefore achieves a real improvement in the characteristics of the spark, by making it possible to best approximate the new resonance conditions of the assembly and, consequently, renders ignition more effective.

Thus, when the frequency of the power supply control signal is abruptly shifted according to the principles mentioned hereinabove, one advantageously passes from a perfectly tuned system, at the moment of the triggering of the plasma generation control, to a “not entirely” mistuned system, at the moment of the formation of the spark, insofar as a decrease in the excitation frequency is brought about which makes it possible to take account of the formation of the spark so as to adapt the control of the resonator of the spark plug to the new resonance conditions.

However, a parameter that is essential to comply with for optimal frequency drive according to the invention of the radiofrequency power supply of the spark plug, is the synchronization of the change of frequency of the power supply control signal with the spark plug resonator excitation signal applied at output of the power supply circuit.

FIG. 2a illustrates a timechart of the spark plug radiofrequency power supply control signal V1, on which is imposed a change of frequency during the application of the radiofrequency spark plug resonator excitation signal V2, whose timechart is also represented opposite the timechart of V1. FIG. 2a presents a case where this change of frequency of the signal V1 is not synchronized with the excitation signal V2.

As illustrated in FIG. 2a, the radiofrequency spark plug resonator excitation signal V2 is, in a first part of the ignition control, driven to the no-load resonant frequency f₀ of the system, defined by the control signal V1.

A change of the frequency of the control signal V1, corresponding to a frequency jump from the initial frequency f₀ to a frequency f₁, chosen, as explained above, in a frequency span lying between f₀ and f₀−(Δf/2), is therefore commanded at a given moment of the ignition control, corresponding preferably to the moment of the formation of the spark, or just before or just after. The new value of control frequency f₁ is for example chosen between f₀ and f₀−100 kHz.

The control signal V1 then passes through a toggling phase of duration t_{b}, in which it is in a low state, preceding the application of the new frequency f₁.

As illustrated in FIG. 2a, the duration t_{b} of toggling of the control signal V1 to the new frequency f₁ is not clamped to the duration of a half-period of the signal V1 before the change of frequency, that is to say corresponding to a half-period of the signal at the frequency f₀ according to the example. The modification of the frequency of the excitation signal V2 which stems therefrom is therefore not synchronized with the duration t_{b} of toggling of the control signal V1 to the new control frequency f₁.

The control signal V1 is then no longer in phase with the oscillations of the excitation signal V2 at the moment of the application of the new frequency f₁.

As a result of this situation, the amplitude of the excitation signal V2 decreases at the moment of the change of frequency, and rises only progressively while realigning with the new control frequency f₁, as illustrated by the timechart of V2 of FIG. 2a.

Thus, subsequent to the losses during the transition, the effectiveness of the system is decreased. Moreover, there are risks for the control power electronics and, in particular, for the MOS breaker forced to the change of state at the moment of passage of a significant current. Indeed, the unsynchronized switching of the power transistor will induce switchings which will no longer be at zero voltage or zero current, thus leading to risks for the transistor.

FIG. 2b, repeating the same timecharts as FIG. 2a, then illustrates the case envisaged by the present invention, where the modification of the frequency of the excitation signal V2 is advantageously carried out in a manner synchronous with the duration t_{b} of toggling of the control signal V1 to the new control frequency f₁.

In this case where the change of frequency of the excitation signal is synchronized with the control signal, a situation is created where the control signal is continually in phase with the oscillations of the excitation signal, including at the moment of the change of frequency. There is therefore no longer any loss of resonance and it is then possible to retain the maximum voltage, while slowing down the voltage drop after passing the point of maximum voltage, corresponding to the formation of the spark at the instant tₘₐₓ of ignition control (cf. FIG. 3).

Such synchronous frequency driving of the resonator makes it possible to maintain the maximum quality factor of the radiofrequency spark plug, whatever the regime under which it is operating, and therefore to preserve the characteristics of the spark.

It is possible furthermore to effect several sudden changes of frequency of the control signal during the application of one and the same excitation signal for the resonator of the radiofrequency spark plug.

As has been seen, any change of frequency of the radiofrequency spark plug resonator excitation signal must be done in synchronism with the control signal.

Accordingly, the duration of toggling t_{b}, through which the control signal V1 passes before application of the new control frequency, must preferably be controlled so as to be substantially equal to the duration of a half-period of the control signal before application of the change of frequency.

A certain tolerance is however possible for the control of the duration t_{b} of toggling of the control signal to the new control frequency. Thus, it has been validated that, generally, for any change of frequency involving a frequency jump from a first frequency f, possibly f₀, to a second frequency f1, typically lying between f₀−(Δf/2) and f₀, the duration t_{b} of toggling of the control signal before application of the new frequency must comply with:

$$0.8 \times \frac{1}{2 f} < tb < 1.2 \times \frac{1}{2 f}$$

Stated otherwise, the duration t_{b} must lie between 80% and 120% of the duration of a half-period of the control signal at the frequency f (that is to say the frequency before application of the new frequency).

Furthermore, for an optimum gain in the amplitude of the voltage U(t) generated by the resonator of the radiofrequency spark plug, a change of frequency of the control signal V1 must be carried out in a transient phase (referenced phase 1 in FIG. 3) of the resonator voltage signal U(t). This transient phase of the signal U(t) precedes a phase of stabilization of this signal (referenced phase 2), knowing that a maximum gain is obtained when the change of frequency occurs substantially at the moment of the formation of the spark, that is to say at the instant tₘₐₓ.

The implementation of frequency jumps with the above-described characteristics specific to the invention require, for onboard applications, the use therefor of high-frequency microprocessors or real-time logic components such as FPGAs (Field Programmable Gate Arrays) or else ASICs (Application Specific Integrated Circuits).

FIG. 4 illustrates an exemplary embodiment of frequency means of drive according to the invention of the control module providing the radiofrequency power supply control signal V1. These drive means are therefore adapted for shifting the frequency of the power supply control signal, from an initial control frequency to a new control frequency, so that the change of frequency of the resonator excitation signal which stems therefrom is synchronized with the control signal. In this way, the control signal remains in phase with the oscillations of the resonator excitation signal, throughout the application of the excitation signal.

According to the example of FIG. 4, the drive means comprise a voltage-controlled oscillator VCO 40, the output of which is connected to the control module 30 so as to provide the control signal V1, and a drive input 41 of which is connected to a drive voltage source 50, adapted for commanding the VCO through a modulation of the drive voltage suitable for controlling a change of the frequency of the control signal provided on the gate of the transistor M.

Thus, the optimization of the development of the spark of the radiofrequency spark plug according to the invention requires the successful recouping of part of the mistuning of the power supply system, by commanding a change of frequency in real time inside an excitation train for the spark plug, while complying with the condition of synchronization of this change with the control signal.

This mode of synchronous frequency driving in real time may be extended to any type of application using a resonant system to first approximation of LC or RLC type, whose intrinsic parameters evolve over time, under any physical effect (such as the production of a spark for example), thus modifying its initial resonant frequency f₀ (increasing it or decreasing it).

Under these conditions, the modification of the excitation frequency of the resonant system must be synchronized, according to the previous description in relation to the plasma generation automobile ignition application, with the time t_{b} of toggling of the control signal to a new value of control frequency, defining the new excitation frequency. The new excitation frequency must furthermore be situated between f₀ and f₀+/−(Δf/2) (depending on whether the resonant frequency has increased or decreased), Δf corresponding to the passband of the resonant system.

The change of resonant frequency of the resonant system may be detected in real time by measuring a quantity characteristic of the resonant system, such as for example the quality factor. The modification of the system excitation frequency must preferably be effected as soon as a variation of the resonant frequency of greater than 10% of the passband Δf is detected.

1-9. (canceled)

10. A radiofrequency plasma generation device, comprising:
a control module generating a control signal at a control frequency;
a power supply circuit comprising a breaker controlled by the control signal, the breaker applying an excitation signal to an output of the power supply circuit at the control frequency defined by the control signal;
a resonator exhibiting a resonant frequency of greater than 1 MHz, connected to the output of the power supply circuit and configured to generate a voltage for producing a spark when it is excited by the excitation signal; and
drive means for the control module, configured to modify the frequency of the resonator excitation signal in a manner synchronous with the control signal, during application of the excitation signal;
the drive means configured to control at least one frequency jump of the control signal from a first frequency value (f₀) to a second frequency value (f₁), less than the first frequency value (f₀).

11. The device as claimed in claim 10, wherein the drive means further controls a duration of toggling of the control signal to the second frequency value, lying between 80% and 120% of a duration of a half-period of the signal at the first frequency value.

12. The device as claimed in claim 10, wherein the first frequency value is substantially equal to the resonant frequency of the resonator when spark-less.

13. The device as claimed in claim 10, wherein the second frequency value lies in a span lying between f₀−(Δf/2) and f₀, f₀ being equal to the resonant frequency of the resonator when spark-less and Δf corresponding to the passband of the resonator.

14. The device as claimed in claim 10, wherein the drive means is further configured to control a frequency jump of the control signal in a transient phase of the voltage signal generated by the resonator, preceding a phase of stabilization of the signal.

15. The device as claimed in claim 10, wherein the drive means is further configured to control the frequency jump of the control signal, substantially at a moment of formation of the spark.

16. The device as claimed in claim 10, wherein the control module drive means comprises a voltage-controlled oscillator and means for modulating a drive voltage of the oscillator.

17. An internal combustion engine, comprising at least one plasma generation device as claimed in claim 10.

18. A method of controlling a power supply of a radiofrequency ignition of a combustion engine, comprising:
applying an excitation signal as an input to a resonator at a first frequency defined by a control signal, the resonator exhibiting a resonant frequency of greater than 1 MHz and configured to generate a voltage for producing a spark when it is excited by the excitation signal;
modifying the frequency of the excitation signal during application of the excitation signal, in a manner synchronous with the control signal; and
controlling at least one frequency jump of the control signal from a first frequency value to a second frequency value, less than the first value.
